(19) United States
(12) Patent Application Publication
(10) Pub. No.: US 2004/0045615 A1
(43) Pub. Date: Mar. 11, 2004

(54) Hydropneumatic pressure reservoir

(76) Inventors: Gernot Rupp, Eppelborn (DE); Markus Lehnert, Dillingen (DE); Herbert Baltes, Losheim (DE)

Correspondence Address: Mark S Bicks, Roylance Abrams Berdo & Goodman, Suite 600, 1300 19th Street N W, Washington, DC, 20036, US

(21) Appl. No.: 10/465,999

(22) PCT Filed: Mar. 9, 2002
(86) PCT No.: PCT/EP02/02626

(30) Foreign Application Priority Data
Mar. 31, 2001 (DE) 101 16 235.9

(51) Int. Cl. F16L 55/04

(52) U.S. Cl. 138/30; 138/26

(57) ABSTRACT

The invention relates to a hydropneumatic pressure reservoir (1) with a housing formed from at least two housing shells (3, 5) which may be connected together. At least the end region of the one housing shell (5) comprises an outwardly-extending, funnel-like guide surface between the free end thereof and a sealing element for bringing together the two housing shells (3, 5). At least one elastic sealing element (41) is provided on at least one retaining surface for generation of a tensioning force on the boundary region (21) of the membrane (13). A simplified construction with improved sealing in the critical connection region of the pressure reservoir may thus be achieved.

The invention relates to a hydropneumatic pressure reservoir having a housing which separates the interior of the reservoir from the external environment, this housing consisting of at least two housing shells connectible to each other, with a cross-section defining a longitudinal axis and a partition separating the interior of the housing into two chambers, a gas chamber and a liquid chamber, the partition being in the form of a gas-tight diaphragm which is clamped by its circumferential edge area to form a seal to the interior wall of the housing by means of a retaining device which has retaining surfaces which receive the edge area of the diaphragm between them and at least one energy storage element generating tension (clamping) force between edge area and retaining surfaces, at least one of the retaining surfaces being formed by a wall component of one of the housing shells, the retaining surfaces extending equidistant from each other over the entire area of their surfaces to form an annular gap between them which has a clear gap width which remains the same over its axial extent, and the retaining surface situated externally in relation to the longitudinal axis on one of the housing shells is part of the jacket surface of a cone whose tip is positioned on the longitudinal axis so that this retaining surface is separated from the longitudinal axis by the greatest axial distance at its end facing the other housing shell.

Comparable pressure reservoirs are disclosed, for example, in DE 25 34 361 B2. Because of the very narrow tolerances such as must be observed in the case of wall components used in conjunction with each other in the connecting area of the housing shells and in that of the surfaces coming in contact with the edge area of the diaphragm, installation of the diaphragm and assembly of the housing shells prove to be a relatively difficult process. Because of the precise fit required, the smallest errors in alignment or inclination relative to the longitudinal axis during assembly of the components result in disruption of the assembly process or even in damage from misalignment or tilting.

EP 1 031 729 A2 discloses a generic hydropneumatic pressure reservoir, there being provided as retaining device for the partition or separating diaphragm a self-contained fastening ring which fastens two housing shells held together under tension. The fastening ring as retaining device forces a diaphragm bead on the end side over a flange-like metal ring into the associated seat in the lower housing shell of the reservoir. In the area of the respective bead seat for the partition or separating diaphragm the housing shells are cylindrical in shape on their guide surfaces facing each other and consequently are in contact with each other. The fastening ring and the lower housing shell extend over a predetermined area below the fastening bead with retaining surfaces extending parallel to and equidistant from each other which delimit a gap and thus maintain the partition over a predetermined distance. If the housing shells come in contact with each other during assembly of the disclosed reservoir, contact mismatch may occur even with precisely worked guide and retaining surfaces, something which impairs the clamping of the diaphragm and its later fastening in the reservoir and may also greatly complicate assembly. The sealing ring mounted between the cylindrical guide surfaces of the two housing halves, which accordingly is positioned outside the diaphragm fastening point, is subjected to no additional clamping force increasing the sealing force, so that tightness problems may arise especially in the event of inaccurate clamping within the framework of the assembly as described.

On the basis of this state of the art the object of the invention is to create a pressure reservoir of the type indicated which is distinguished by construction permitting especially simple assembly and does not exhibit the disadvantages in the state of the art as described. An object as thus formulated is attained by a hydropneumatic pressure reservoir having the characteristics specified in claim 1 in its entirety.

In that, as specified in the descriptive portion of claim 1, at least the end area of one housing shell has between its free end and the respective sealing element a funnel-shaped guide surface expanding outward for bringing the two housing shells together, and in that at least one flexible sealing element is provided on at least one retaining surface for generation of a clamping force acting on the edge area of the diaphragm, achievement of a situation is accomplished such that the retaining surfaces extend equidistant from each other over the entire area of their surface so as to form between them an annular gap the clear width of which remains the same over its axial extent.

There is thus created the possibility claimed for the invention of configuring the end areas of the housing shells to be connected and the retaining configuration so that the end area of the housing shell which forms the external retaining surface for clamping the diaphragm forms a guide surface widening outward like a funnel when the two housing shells are brought together. Since the other retaining surface associated with the other housing shell, the internal retaining surface in relation to the longitudinal axis, is equidistant from the other retaining surface in formation of the annular gap seating the edge area of the diaphragm, that is, with the housing halves in the assembled state, a kind of self-centering accordingly occurs in the process of assembly of the housing shells because of the funnel-shaped configurations of the guide surfaces, so that trouble-free assembly by simple means is made possible, in an especially precisely defined contact situation for the edge of the partition or separating diaphragm. In addition, in the overall situation as presented sure sealing between the interior of the reservoir and the external environment is achieved as a result of incorporation of the flexible sealing element exerting a direct effect on the edge area of the diaphragm. Since, in addition, the sealing element may affect the associatable edge area of the diaphragm by application of an active pretensioning force, the sealing force is appreciably improved and the position of the diaphragm in relation to its edge area is precisely defined, this favoring lengthening of the service life of the diaphragm as a whole.

In an especially preferred embodiment of the pressure reservoir claimed for the invention one housing shell has another guide surface narrowing inward in the form of a funnel for establishment of contact with the other housing shell. When the two housing shells have been brought into contact with each other, the two guide surfaces are kept in contact with each other and/or equidistant from each other. As a result, precise centering of one housing shell relative to the other housing shell is effected. In close-tolerance centering the guide surfaces in question may also be used in creation of other sealing surfaces of the reservoir.

In another preferred embodiment of the pressure reservoir claimed for the invention, the outer retaining surface extends in length and accordingly with the same inclination as the guide surface associated with it. If the centering is precisely adjusted, the guide surfaces in question may in this way participate in configuration of other sealing surfaces of the reservoir.

In another preferred embodiment of the pressure reservoir claimed for the invention, the outer retaining surface is in the form of an extension and accordingly extends with the same inclination relative to the guide surface associated with it. The inner retaining surface preferably extends in parallel with the outer retaining surface, being mounted offset one step inward toward the longitudinal axis of the reservoir. On the basis of the respective configuration the retaining surfaces may be designed as an obvious continuation of the guide surfaces, and this appreciably lowers the production costs.

In one preferred embodiment of the pressure reservoir the retaining device may be formed directly from the two housing shells and an additional fastening ring may be entirely omitted. But it is also possible, while retaining the advantages of the invention, in another embodiment to produce the respective configuration by using a fastening ring, but this increases the variety of components and accordingly the production costs.

In another preferred embodiment of the pressure reservoir claimed for the invention, the length of each guide surface is shorter than the length of each associated retaining surface. The respective configuration guarantees both availability of retaining surfaces of a size which serves to effect secure fastening of the diaphragm material while not impairing the centering situation by way of the guide surfaces on the other side, and also ensures the respective centering over the entire circumference.

The preferred range of the angle at which the outlying retaining surface extends outward in the form of a funnel relative to the longitudinal axis is 4° to 10°, preferably 5° to 6°.

The advantage of the simplified assembly remains undiminished, regardless of the method employed to configure the force reservoir element which is used to generate the clamping force required to clamp and seal the edge area of the diaphragm with the gap width kept constant.

The retaining surface positioned inside relative to the longitudinal axis may be, for example, in the form of a projection on one housing shell which may be inserted into the other housing shell. If in this case the projection is designed to be integral with the other housing shell, at least one flexible sealing element mounted between at least one retaining surface and the edge area of the diaphragm may be provided as the force storage element generating the clamping force between the edge area of the diaphragm and the retaining surfaces.

As an alternative the projection present on one housing shell, which may be inserted into the other housing shell and forms the inner retaining surface, may also be in the form of a clamp ring which is connected to the pertinent housing shell by way of a spring-mounted intermediate element which serves as force storage element for generation of the clamping force acting on the edge area of the diaphragm. In both instances the circumferential edge components which may be inserted into a housing shell extend inward at a small angle of taper and accordingly are of a configuration well-suited for easy and reliable assembly.

In one preferred exemplary embodiment the edge area of the diaphragm has a bead-like thickening seated between the retaining surfaces and an elastic sealing ring adjoining the end edge or spray applied to this end edge as sealing element generates a clamping force between the bead-like thickening and support surfaces which are formed on both ends of the housing shell and which extend transversely to the retaining surfaces.

The invention is explained in detail in what follows with reference to the exemplary embodiments illustrated in the drawing, in which

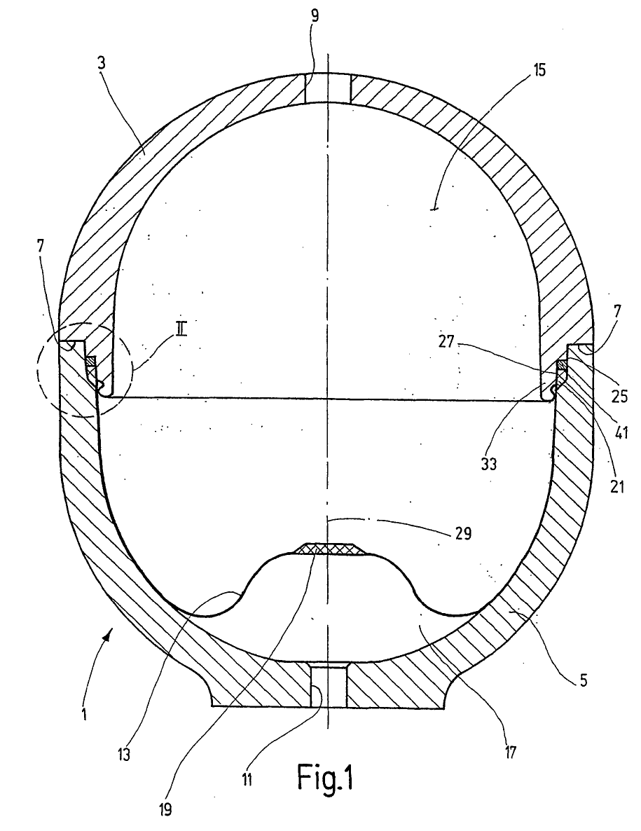

FIG. 1 shows a longitudinal section of a pressure reservoir in accordance with one exemplary embodiment of the invention;

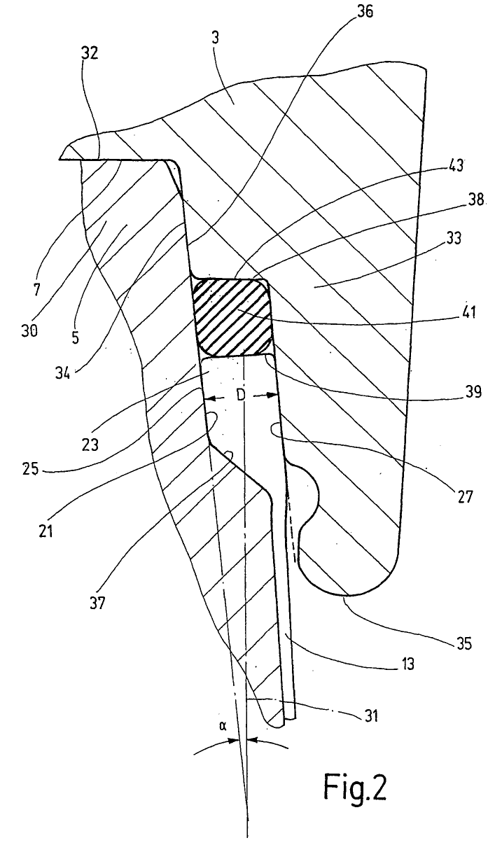

FIG. 2 a detached section on a larger scale of the area designated as II in FIG. 1;

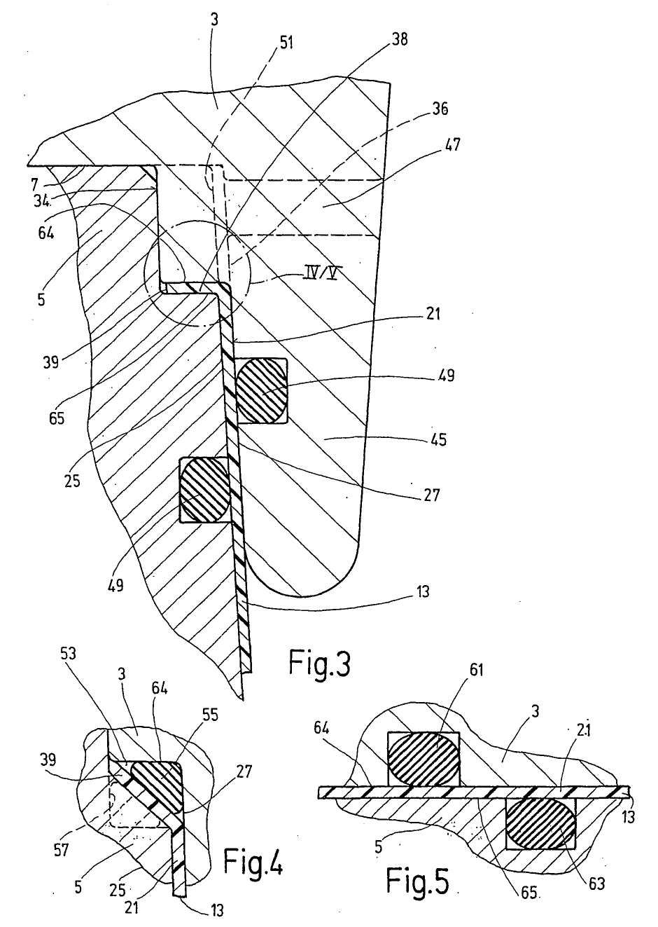

FIG. 3 a detached section on the same scale as that of FIG. 2 of the corresponding area of a pressure reservoir in accordance with a modified exemplary embodiment; and

FIGS. 4 and 5 detached partial sections of the area identified as IV and V in FIG. 3, but with a third and fourth exemplary embodiment illustrated.

A pressure reservoir designated as a whole as 1 in FIG. 1 has two housing shells 3 and 5 which are approximately hemispherical in shape and are connected to each other at a seam 7. As is customary in the case of such pressure reservoirs, the housing shells 3 and 5 are connected to each other at the seam 7 by electron beam welding or laser welding so as to be gas-tight. Each of the housing shells 3 and 5 has an opening 9 or 11, which is provided for addition of a connection mounting (not shown) which produces connection to a gas intake and refill system or hydraulic system (also not shown).

The interior of the housing is divided by a partition in the form of a gas-tight diaphragm 13 into an upper gas chamber 15 in FIG. 1 and lower liquid chamber 17 adjoining the opening 11. The diaphragm 13 may be in the form of an elastomer material or, preferably, of a plastic material. It may be a monolayer diaphragm consisting of a polyamide such as PA6 or a polyamide blend such as polyamide-polyolefine, or of polyethylene terephthalate, polyethylene naphthalate, or polyvinylidene chloride. In the case of a multilayer diaphragm the plastics in question may be provided as a sealing layer to which a cover layer or layers is or are applied.

The diaphragm 13 is shown in FIG. 1 in an incompletely extended state. In the completely extended state, which corresponds to the smallest volume of the liquid chamber 17, a reinforcement 19 applied by adhesive or sprayed on, acting as a sort of valve disk, would be positioned above the inner edge of the opening 11 and would not only effect sealing but also prevent forcing of the diaphragm 13 into the opening 11 by the pressure prevailing in the gas chamber 15. The reinforcement 19 may also be in the form of a thickening of the material of the diaphragm 13 itself.

FIG. 2 shows the area designated as II in FIG. 1 on a larger scale so as to present in greater detail the configuration of the edge area 21 of the diaphragm 13 and of the retaining device for clamping the diaphragm 13. In the exemplary embodiments shown in FIGS. 1 and 2, the edge area 21 of the diaphragm 13 has a bead-like thickening 23 which is seated between two retaining surfaces, that associated with the housing shell 5 being designated as 25 and that associated with the housing shell 3 as 27. The retaining surfaces 25 and 27 extend over the entire circumference of the pressure reservoir housing equidistant from each other, so that between themselves they form an annular gap for seating of the edge area 21 of the diaphragm 13, this annular gap being of a constant clear gap width D over its axial extent (FIG. 2).

In FIG. 1 the longitudinal axis of the pressure reservoir 1 defined by the approximately spherical form of the housing shells 3 and 5 is designated as 29. The longitudinal direction of the pressure reservoir defined by this longitudinal axis 29 is illustrated in FIG. 2 by a guide line 31, which extends in parallel with the longitudinal axis 29. As is clearly to be seen in FIG. 2, the retaining surface 25 positioned on the outside in relation to the longitudinal axis 29 is inclined at a very acute angle α to the longitudinal direction indicated by the guide line 31, that is, relative to the longitudinal axis 29. The outer retaining surface 25 consequently is part of the jacket surface of a cone whose tip lies on the longitudinal axis 29 of the pressure reservoir. FIG. 2 shows that the outer retaining surface 25 inclines at a small angle α, which is about 4° to 10°, to the longitudinal axis 29 so that the retaining surface 25 is separated from the longitudinal axis 29 by the greatest radial distance at its upper end in FIG. 2, that is, at its end facing the housing shell 3. The end of the lower housing shell 5 shown in FIGS. 1 and 2 facing the housing shell 3 accordingly expands slightly on the edge side in the form of a funnel. The end component of the other, upper, housing shell 3 to be inserted into the slightly expanded open end of the housing shell 5, which end component is designed in a suitable, complementary configuration in order to define the inner retaining surface 27 with the projection 33 of the housing shell 3 inserted into the housing shell 5, accordingly has in its end area projecting during the connection process an external diameter which is smaller than that of the opening at the open end edge of the housing shell 5 forming a sort of “insertion funnel.” Assembly of the housing shells 3 and 5 is accordingly simple and free of problems, since the projecting end area 35 of the housing shell 3 can be immediately fitted over the thickening 23 of the edge area 21 of the diaphragm 13 applied to the retaining surface 25. As is clearly to be seen in FIG. 2, the outer retaining surface 25 has on its lower end shown in the figure a support surface 37 extending transversely with which extends diagonally relative to this retaining surface, this support surface 37 forming a seat for the thickening to prevent displacement along the retaining surface 25.

One housing shell 5 is provided in the direction of its outer end with a guide surface 34 widening slightly outward as a funnel for bringing the two housing shells 3, 5 together. The other housing shell 3 is provided with another guide surface 36 narrowing inward also as a funnel, the two guide surfaces 34, 36 being in contact with each other when the two housing shells 3,5 have been brought together. In addition, the outer retaining surface 25 is mounted to extend longitudinally and thus at the same angle of inclination as the guide surface 34 associated with it. The inner retaining surface 27 in turn extends in parallel with the outer retaining surface 25, being offset inward relative to the longitudinal axis 29 by a step 38, and the length of each guide surface 34, 36 is shorter than the length of each associated retaining surface 25, 27. In addition, one guide surface 34 of the housing shell adjoins the free end 32 of the latter.

The retaining device in question for the diaphragm partition may be formed directly from the two housing shells 3, 5 or at least in part by a self-contained fastening ring (not shown) which may be introduced into one of the two housing shells 3, 5, in particular into the lower housing shell 5.

In the example illustrated in FIGS. 1 and 2 the projection 33 is integral with the housing shell 3 at the top in the figure. The projection 33 thus forms a rigid connection with the housing shell 5. An elastic sealing element 41 adjoining the end edge 39 of the thickening 23 is provided as force storage element for generation of a clamping force for clamping and sealing of the edge area 21 of the diaphragm 13. This sealing element is in the form of an O-ring clamped between the retaining surfaces 25 and 27 and applies to the end edge 39 of the thickening 23 a clamping force acting in the axial direction between a support surface 43 extending transversely to the retaining surface 27 and the support surface 37 extending transversely to the retaining surface 25. In addition, the sealing element 41 effects sealing both from the retaining surface 25 and from the retaining surface 27. The sealing element 41 is applied to the end edge 39 of the thickening 23 of the diaphragm 13 by adhesion or by spray application.

FIGS. 3 to 5 illustrate other exemplary embodiments of the configuration of the retaining device for clamping and sealing the edge area 21 of the diaphragm 13, the edge area 21 in such cases having no thickening on the end side such as has been provided in the previous exemplary embodiment and designated as 23.

In the second exemplary embodiment illustrated in FIG. 3 the projection of the upper housing shell 3 in the figure, which projects into the housing shell 5, is not designed to be integral with the housing shell 3 as was the case in the example previously described in the case of the projection 33. Rather a clamp ring 45 associated with the housing shell 3 is provided as projection, this clamp ring 45 being connected to the pertinent housing shell 3 by way of a spring-loaded intermediate element 47. The latter serves as force storage element which generates an axial force pretensioning the clamp ring 45 into the housing shell 5 when the pressure reservoir has been assembled. This axial force acts as clamping force between the retaining surfaces 25 and 27, which are essentially similar to the retaining surfaces 25 and 27 of the first exemplary embodiment and receive the edge area 21 of the diaphragm 13 to be seated between them. In addition, sealing elements 49 like O-rings are mounted on both sides of the edge 21 of the diaphragm 13; they serve both to provide sealing and act as additional force storage elements generating a clamping force.

Broken lines 51 in FIG. 3 illustrate an extended course of the edge area 21 of the diaphragm 13 up to the area of the seam 7 of the housing shells. As an alternative, a solid line illustrates a variation in which the end area 39 of the diaphragm 13 is folded outward. This area is identified by a circle in FIG. 3 designated as IV/V. Two optional configurations of this area IV/V are illustrated in FIGS. 4 and 5 as third and fourth exemplary embodiments.

FIG. 4 shows that the end area 39 is folded diagonally outward, there being formed in the upper housing shell 3 shown in the figures an annular groove 53 in which is seated a sealing element in the form of a shaped sealing ring 55, in particular one in the form of an O-ring. The latter is supported both by the inner retaining surface 27 and by the surface 64 extending transversely to the latter in order to form a clamping force and a seal on the adjoining surface on the end area 39 of the diaphragm 13. FIG. 4 illustrates as an alternative type of construction indicated by broken lines 57 the formation of another annular gap on the upper end of the outer retaining surface 25, a sealing element corresponding to the sealing ring 55 being seated in this annular gap.

Lastly, FIG. 5 illustrates a fourth exemplary embodiment, one in which, in the area identified as IV/V in FIG. 3, sealing elements 61 and 63 are seated on both sides in annular grooves on the edge area 21 folded outward of the diaphragm 13, these sealing elements 61 and 63 in turn serving both as additional force storage elements for clamping force generation and as seals. The respective sealing elements are preferably used in pairs, sealing off from the gas side and from the hydraulic side. It is also possible, however, with an appropriate design of the diaphragm 13, for the latter to perform exclusively the function of sealing on the oil side.

1. A hydropneumatic pressure reservoir (1) with a housing made of at least two housing shells (3, 5) which may be connected to each other, such housing separating the interior of the reservoir from the external environment, with a cross-section defining a longitudinal axis (29) and a partition dividing the interior of the housing into two chambers, in particular a gas chamber (15) and a liquid chamber (17), a partition in the form of a gas-tight diaphragm (13) which is clamped by its circumferential edge area (21) to effect sealing to the inner wall of the housing by means of a retaining device which has retaining surfaces (25, 27) which seat the edge area (21) of the diaphragm (13) between themselves and at least one force storage element (41, 47) generating a clamping force between edge area (21) and retaining surfaces (25, 27), at least one (25) of the retaining surfaces (25, 27) being formed by a wall component of the housing shells (3, 5), the retaining surfaces (25, 27) extending equidistant from each other over their entire surface area in order to form between themselves an annular gap which has a constant clear gap width (D) over its axial extent, and the retaining surface (25), external in relation to the longitudinal axis (29), situated on one (5) of the housing shells (3,5) being part of the jacket surface of a cone whose tip is positioned on the longitudinal axis (29) so that this retaining surface (25) is separated, at its end facing the other housing shell (3), by the greatest radial distance from the longitudinal axis (29), characterized in that at least the end area (30) of one housing shell (5) has, between its free end (32) and the respective sealing element (41, 49), a guide surface (34) flaring outward in the form of a funnel for moving the two housing shells (3, 5) together and in that at least one elastic sealing element (41, 49) is provided on at least retaining surface (25, 27) for the purpose of generation of a clamping force acting on the edge area (21) of the diaphragm (13).

2. The pressure reservoir as claimed in claim 1, wherein the housing shell (3) to be brought together with the other housing shell (5) has another guide surface (36) narrowing inward like a funnel and wherein, when the two housing shells (3, 5) have been brought together, the two guide surfaces (34, 36) are in contact with each other and/or remain equidistant from each other.

3. The pressure reservoir as claimed in claim 1 or 2, wherein the outer retaining surface (25) extends in length and thus at the same inclination to the guide surface (34) associated with it.

4. The pressure reservoir as claimed in claim 3, wherein the inner retaining surface (27) is positioned so as to extend in parallel with the outer retaining surface (25), being offset inward one step (38) toward the longitudinal axis (29) of the reservoir (1).

5. The pressure reservoir as claimed in one of claims 1 to 4, wherein the retaining device is formed directly by the two housing shells (3, 5) or at least in part by a fastening ring which may be introduced at least into one or both housing shells (3, 5).

6. The pressure reservoir as claimed in claim 4 or 5, wherein the length of each guide surface (34, 36) is shorter than the length of each associated retaining surface (25, 27).

7. The pressure reservoir as claimed in one of claims 1 to 6, wherein the angle (α) of the cone which defines the retaining surface (25) formed on one housing shell (5) in relation to the longitudinal axis (29) amounts to 4° to 10°.

8. The pressure reservoir as claimed in one of claims 1 to 7, wherein the retaining surface (27) positioned inside in relation to the longitudinal axis (29) is formed on a projection (33, 45) of the other housing shell (3) which may be inserted into one housing shell (5).

9. The pressure reservoir as claimed in one of claims 1 to 8, wherein the edge area (21) of the diaphragm (13) has a bead-like thickening (23) seated between the retaining surfaces (25, 27) and wherein an elastic sealing ring (41) positioned on or applied by spraying to the end edge (39) of the thickening (23) is provided as sealing element, which sealing ring (41) generates a clamping force between the bead-like thickening (23) and support surfaces (37, 43), which are formed on each of the housing shells (5 or 3) and which extend transversely to the retaining surfaces (25, 27).

10. The pressure reservoir as claimed in one of claims 1 to 9, wherein the projection forming the inner retaining surface (27) is in the form of a clamp ring (45) which is connected to the associated housing shell (3) by way of a spring-loaded, gas-sealing intermediate element (47) which, in order to generate the clamping force acting on the edge area (21) of the diaphragm (13), generates on the retaining surface (27) associated with the clamp ring (45) a pretensioning force which seeks to displace this retaining surface (27) in an axial direction.

11. The pressure reservoir as claimed in one of claims 1 to 10, wherein the edge area (21) of the diaphragm is folded over outward in its end section (39) projecting over the end of the outer retaining surface (25) and is seated by this end section in the space between the seating surfaces (65 or 64) formed on one housing shell (5) and the other housing shell (3), which seating surfaces (65 or 64) lie in planes extending transversely to the longitudinal axis (29).

12. The pressure reservoir as claimed in claim 11, wherein there is provided, at least on the seating surface (64, 65) of one of the housing shells (3, 5), at least one elastic sealing element (55, 61, 63) for formation of a seal on the end section (39) or the diaphragm (13) and/or for generation of a clamping force pressing the end section (39) against the seating surface (64, 65) positioned opposite such surface.
